(19) United States
(12) Patent Application Publication
(10) Pub. No.: US 2012/0113054 A1
(43) Pub. Date: May 10, 2012

(54) RESISTIVE FILM TYPE TOUCH PANEL WITH PRESSING DETECTION FUNCTION

(76) Inventors: Takao Hashimoto, Kyoto (JP); Kazuhiro Nishikawa, Kyoto (JP); Yoshihiro Kai, Kyoto (JP); Yuko Endo, Kyoto (JP)

(21) Appl. No.: 13/379,156

(22) PCT Filed: Jun. 10, 2010
(86) PCT No.: PCT/JP2010/059823

§ 371 Date: Dec. 19, 2011

(30) Foreign Application Priority Data
Jun. 19, 2009 (JP) 2009-147067

(51) Int. Cl. G06F 3/045

(52) U.S. Cl. 345/174

(57) ABSTRACT

There is provided a resistive film type touch panel with a pressing detection function capable of detecting not only a pressed position (X, Y coordinates) of a screen, but also a Z direction (pressure) at the same time, superior in visibility, and low in cost. According to a resistive film type transparent touch panel, a first member and a second member are bonded with a transparent bonding layer having many uniformly dispersed through holes between the first and second transparent conductive films, and a conductive pressure sensitive ink member is arranged in each of the through holes, formed on at least one surface of opposed surfaces of the first member and the second member, and has electric characteristics to be changed by an applied pressed force.

### TECHNICAL FIELD

The present invention relates to a resistive film type touch panel with a pressing detection function to measure a pressure of an external force applied to a surface as a component in a direction vertical to the surface.

### BACKGROUND ART

Conventionally, there is a screen input device in which a touch panel is overlappingly mounted on a display screen of an image display device such as a liquid crystal display, and a button displayed on the display screen, for example, is selected by a pressing operation on the touch panel. The touch panel comes in a resistive film type (refer to Patent Document 1, for example), and an optical type, and the resistive film type touch panel has been widely spread because the resistive film type touch panel is simple in structure and low in cost.

The resistive film type touch panel detects a contact position between transparent conductive films formed on upper and lower panels, as a change in resistance value, and the resistive film type touch panel is composed as shown in FIGS. 6 and 7. The resistive film type touch panel includes a lower panel 50 and an upper panel 60 which are oppositely arranged. The lower panel 50 has a transparent conductive film 52 of ITO or the like serving as a resistive film formed on almost an entire surface of an upper surface of a glass plate 51, and position detecting electrodes 53a and 53b formed at both ends in an X direction in the figure. In addition, the upper panel 60 has a transparent conductive film 62 of ITO or the like serving as a resistive film formed on almost an entire surface of a lower surface of a flexible transparent resin film 61, and position detecting electrodes 63a and 63b formed at both ends in a Y direction in the figure. In addition, as shown in an enlarged cross-sectional view in FIG. 8, the lower panel 50 and the upper panel 60 are opposed through dot spacers 54 each formed of a transparent insulator, and at a normal time, the upper and lower transparent conductive films 52 and 62 are wholly spaced through an air layer (hereinafter, referred to as an air gap) due to a frame bonding layer 70.

The electrode 53a of the lower panel 50 and the electrode 63b of the upper panel 60 are connected to a power supply through switches SW1 and SW2, respectively, and the electrode 53b of the lower panel 50 and the electrode 63a of the upper panel 60 are grounded through switches SW3 and SW4, respectively.

When a position of a point P of the upper panel 60 of the resistive film type touch panel is pressed, the transparent resin film 61 is bent, and the upper and lower transparent conductive films 52 and 62 are brought into contact with each other. At this time, when the switches SW1 and SW3 are turned on, and the switches SW2 and SW4 are turned off, a power supply voltage Vcc and the ground voltage are applied between the electrodes 53a and 53b, so that a partial voltage of the power supply voltage Vcc is obtained from the electrode 63a based on a position x of the point P in an X direction. This is outputted to a detection circuit (not shown) as an X coordinate detection signal. Similarly, when the switches SW2 and SW4 are turned on, and the switches SW1 and SW3 are turned off, the power supply voltage Vcc and the ground voltage are applied between the electrodes 63a and 63b, so that a partial voltage of the power supply voltage Vcc is obtained from the electrode 53b based on a position y of the point P in a Y direction. This is outputted to the detection circuit (not shown) as a Y coordinate detection signal.
Patent Document 1: Japanese Unexamined Patent Publication No. 2002-259057

### SUMMARY OF INVENTION

### Technical Problem

Recently, in an electronic device having a touch panel, especially in a mobile electronic device such as a mobile phone or a game machine, it is required to add a pressing detection function to the touch panel, as an alternative to an Enter button. However, according to the resistive film type touch panel in Patent Document 1, only a pressed position (X, Y coordinates) can be detected, but a pressed pressure (Z direction) cannot be detected.

In addition, according to the resistive film type touch panel in Patent Document 1, since the air gap wholly exists between upper and lower transparent conductive films, light reflection generated at a boundary with the air layer is high, so that visibility is no good in a display section of the image display device.

In addition, a material which is superior in transparency, conductivity, and durability such as an ITO (indium tin oxide) is needed as a material for the upper and lower transparent conductive films, but in addition to the resistive film type touch panel, the demand for ITO expands for an organic EL panel, solar battery, and blue light emitting diode. Since In (indium) as a main component of the ITO is a rare metal, depletion of energy source grows into a serious problem. In view of In reserve, the prediction is that it will deplete in 2011 after continued to be used at this rate, and a sense of crisis is heightened. As a result, a price of In considerably rises, and it becomes difficult to provide the touch panel at a low cost.

Therefore, it is an object of the present invention to solve the above problems, and to provide a resistive film type touch panel with a pressing detection function which can detect not only a pressed position (X, Y coordinates) on a screen, but also a Z direction (pressure) at the same time, is superior in visibility, and low in cost.

### Solution to Problem

The present invention provides a resistive film type touch panel with a pressing detection function having the following configuration, in order to solve the above technical problems.

According to a first aspect of the present invention, there is provided a resistive film type touch panel with a pressing detection function serving as a resistive film type transparent touch panel provided by overlapping

a first member having a first transparent conductive film serving as a resistive film on an upper surface of a transparent plate, and a pair of first position detecting electrodes provided at both ends of the first transparent conductive film in a first direction, and

a second member having a second transparent conductive film serving as a resistive film on a lower surface of a flexible transparent film, and a pair of second position detecting electrodes provided at both ends of the second transparent conductive film in a second direction perpendicular to the first direction, in such a manner that the first and second transparent conductive films are opposed through a predetermined gap,

wherein a pressed point is detected based on a potential of the pair of the first and second position detecting electrodes,

the touch panel characterized in that the first member and the second member are bonded with a transparent bonding layer having many uniformly dispersed through holes between the first and second transparent conductive films, and

a conductive pressure sensitive ink member is arranged in each of the through holes, formed on at least one surface of opposed surfaces of the first member and the second member, and has electric characteristics to be changed by an applied pressed force.

According to a second aspect of the present invention, there is provided the resistive film type touch panel with the pressing detection function, according to the first aspect, wherein

the pressure sensitive ink member is a dot having a diameter of 0.01 mm to 1 mm, and the through hole and the pressure sensitive ink member in the through hole are arranged at a pitch of 0.1 mm to 10 mm.

According to a third aspect of the present invention, there is provided the resistive film type touch panel with the pressing detection function, according to the first or second aspect, wherein

the pressure sensitive ink member is arranged on the first member.

According to a fourth aspect of the present invention, there is provided the resistive film type touch panel with the pressing detection function, according to any one of the first to third aspects, wherein

the pressure sensitive ink member is in contact with both surfaces opposed to the first member and the second member.

According to a fifth aspect of the present invention, there is provided the resistive film type touch panel with the pressing detection function, according to any one of the first to fourth aspects, wherein

the through hole is formed to have a diameter larger than that of the pressure sensitive ink member by 0.05 to 2 mm.

### Advantageous Effects of Invention

According to the resistive film type touch panel with the pressing detection function in the present invention, the first and second transparent conductive films are not directly brought into contact with each other at a pressed point, but electrically connected through the pressure sensitive ink member. That is, a resistance value of the pressure sensitive ink member is lowered when a load is applied to the pressure sensitive ink member, and the connection is made. At this time, the load is to be determined as an input when the resistance value of the pressure sensitive ink member exceeds a certain threshold value, so that the pressed position (X, Y coordinates) can be detected even when the first and second transparent conductive films are not directly in contact with each other. In addition, the Z direction (pressure) in that position can be detected at the same time, based on how much the resistance value of the pressure sensitive ink member is lowered.

In addition, since the first member and the second member are bonded with the transparent bonding layer having the many uniformly dispersed through holes between the first and second transparent conductive films, the air gap only exits in the through holes between the upper and lower transparent conductive films. Therefore, light reflection generated at a boundary with the air layer is low, so that visibility is improved in the display section of the image display device.

In addition, when the pressure sensitive ink member is formed of a material having durability, the first and second transparent conductive films may be formed of an inexpensive material which does not need to have durability, so that the touch panel can be provided at a low cost.

### BRIEF DESCRIPTION OF THE DRAWINGS

FIG. 1 is a schematic exploded perspective view of main components of a touch panel according to one embodiment of the present invention.

FIG. 2 is a schematic exploded perspective view of decorative components of the touch panel according to the one embodiment of the present invention.

FIG. 3 is a schematic cross-sectional view of the touch panel according to the one embodiment of the present invention.

FIG. 4 is a perspective view of a mobile phone having the touch panel according to the one embodiment of the present invention.

FIGS. 5A and 5B are cross-sectional views taken along line A1-A1 in FIG. 4.

FIG. 6 is a cross-sectional view showing a schematic configuration of a conventional touch panel.

FIG. 7 is an exploded perspective view showing the schematic configuration of the conventional touch panel.

FIG. 8 is an enlarged cross-sectional view of the conventional touch panel.

### DESCRIPTION OF EMBODIMENTS

Hereinafter, a best embodiment of the present invention will be described with reference to the drawings.

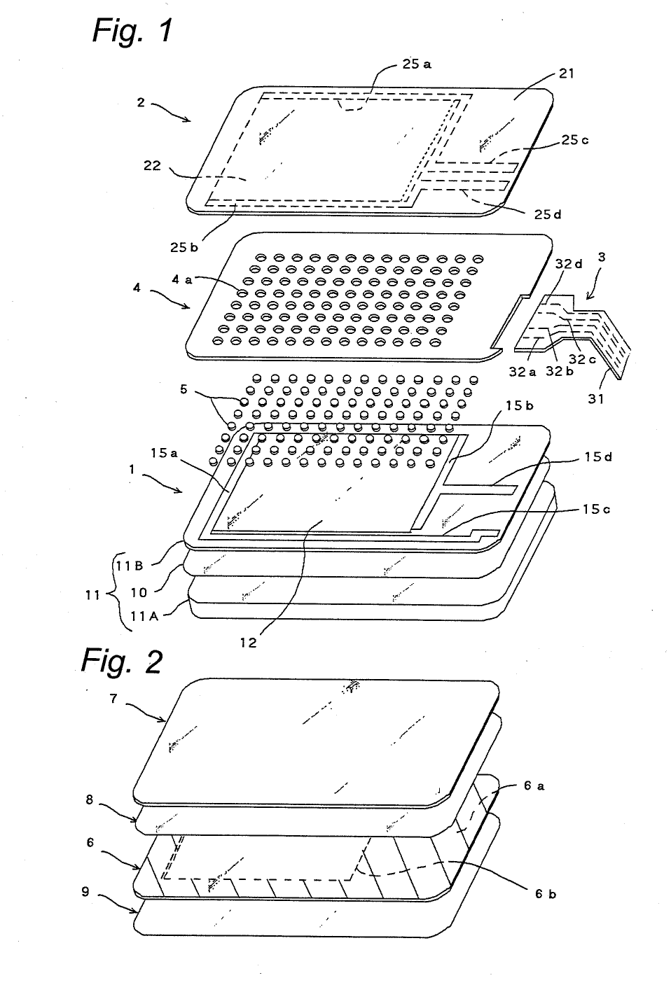

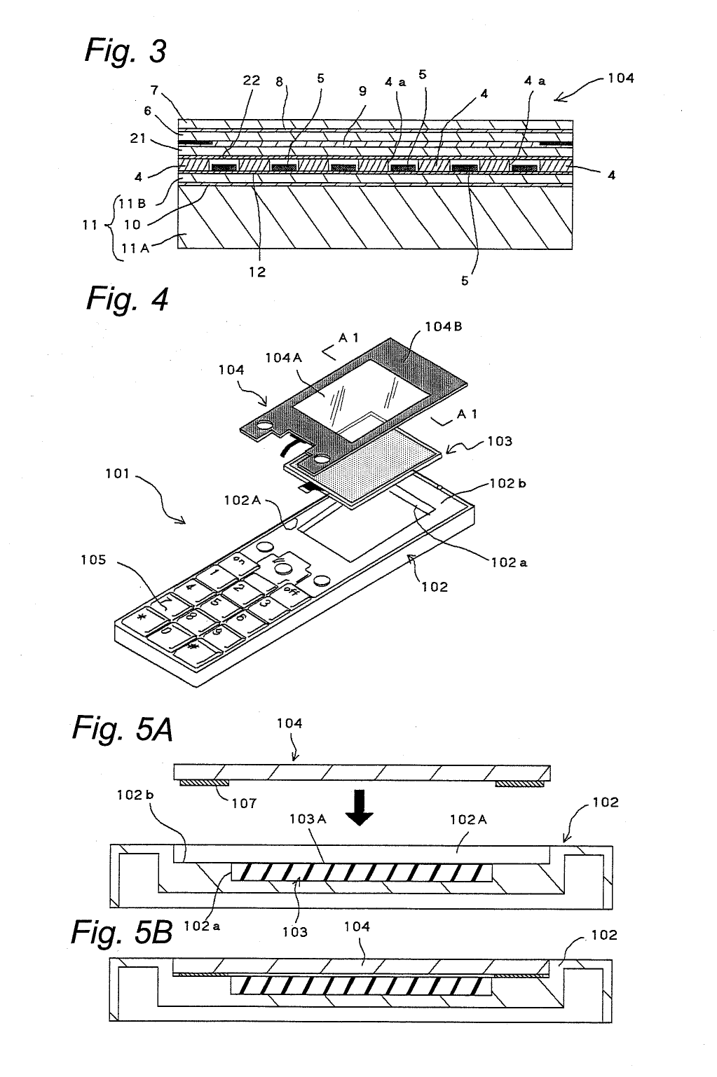

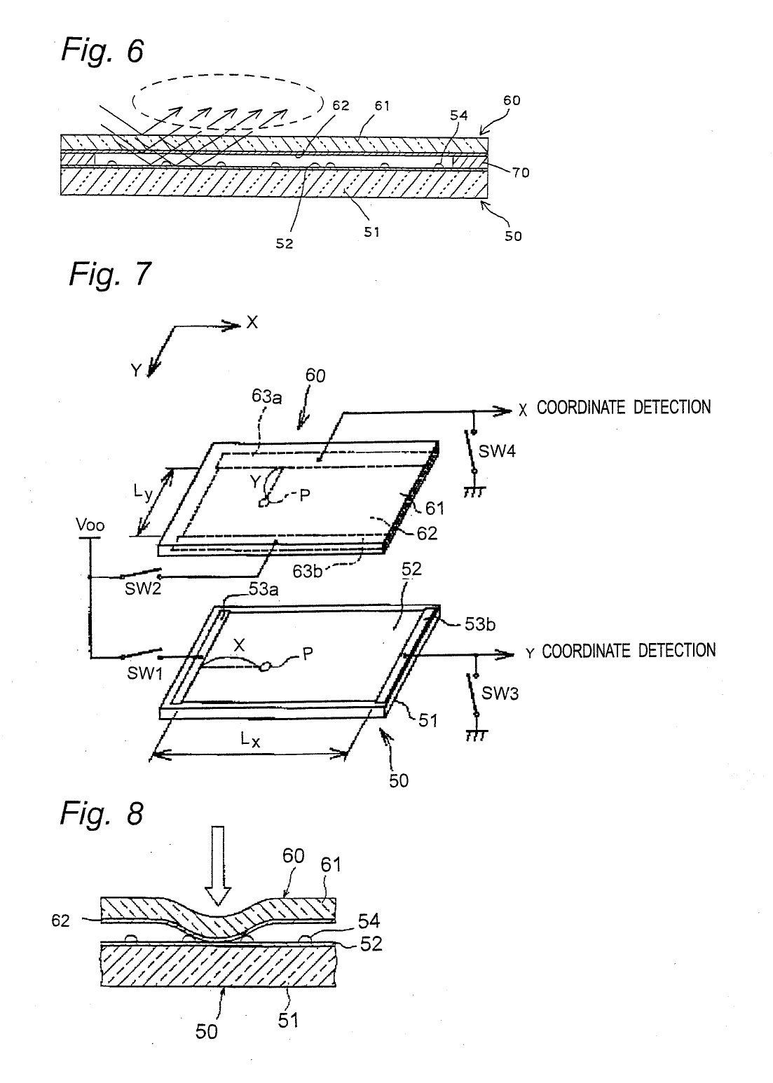

FIG. 1 is a schematic exploded perspective view of main components of a touch panel according to one embodiment of the present invention, and FIG. 2 is a schematic exploded perspective view of decorative components of the touch panel according to the one embodiment of the present invention. In addition, FIG. 3 is a-schematic cross-sectional view of the touch panel according to the one embodiment of the present invention. A touch panel 104 includes a lower panel 1 serving as a first member and an upper panel 2 serving as a second member which are oppositely arranged, an FPC 3 serving as a connector connected to ends of the upper panel 2 and the lower panel 1 to be electrically connected to an external circuit, a transparent bonding layer 4 to bond the first member and the second member, and a pressure sensitive ink member 5 to detect a pressed position and strength of a pressed force (see FIGS. 1 and 3). In addition, according to this embodiment, a decorative film 6 and a hard coat film 7 shown in FIG. 2 are sequentially bonded to a surface of upper panel 2 opposite to the surface opposed to the lower panel 1, with PSAs (Pressure Sensitive Adhesive) 8 and 9 to compose the second member.

The lower panel 1 is composed as will be described below. That is, a transparent conductive film 12 serving as a resistive film (also referred to as the transparent electrode) is formed on an upper surface of a transparent plate 11. The transparent conductive film 12 is formed on an entire surface and its periphery is removed by etching or coated with an insulating layer to insulate a periphery of the lower panel 1. Then, a conductive paste is formed at both ends opposed in the X direction, as position detecting electrodes (also referred to as bas bars) 15a and 15b of the lower panel 1, and as routing wires 15c and 15d routed from the electrodes 15a and 15b to an FPC connection section.

In general, the transparent plate 11 is made of a material superior in transparency, rigidity, and processability, such as a glass plate, polymethyl methacrylate (PMMA) resin, or polycarbonate (PC) resin plate 11A. Alternatively, as shown in FIG. 1, a transparent resin film 11B such as a PET film or PC film may be bonded to an upper surface of the above plate with a PSA 10.

The transparent conductive film 12 includes a thin film made of a metal oxide such as a tin oxide, antimony oxide, zinc oxide, or cadmium oxide, or a conductive polymer. When the pressure sensitive ink member 5 is formed of a material superior in durability, the above inexpensive material which does not need to have durability can be used for the transparent conductive film 12.

The transparent conductive film 12 is formed by a method such as vacuum vapor deposition, sputtering, ion plating, CVD, or roll coating. The etching can be performed such that a resist is formed on a part to be left as the electrode by photolithography or screening, and thereafter, the lower panel is dipped in an etching solution of hydrochloric acid or the like. In addition, the etching may be performed such that the resist is formed, and then, a conductive film on which the resist is not formed is removed by spraying the etching solution, and then the resist is dipped in a solvent and swollen or dissolved to be removed. In addition, the etching may be performed by laser.

The conductive paste to form the electrodes 15a and 15b, and the routing wires 15c and 15d may be a paste of a metal such as gold, silver, copper or nickel, or carbon. These are formed by a printing method such as screen printing, off-set printing, gravure printing, or flexographic printing, a photoresist method, or the like.

Meanwhile, the upper panel 2 is composed as will be described below. That is, a transparent conductive film 22 serving as a resistive film (also referred to as the transparent electrode) is formed on a lower surface of a flexible transparent resin film 21. The transparent conductive film 22 is formed on an entire surface and its periphery is removed by etching or coated with an insulating layer to insulate a periphery of the upper panel 2. Then, a conductive paste is formed at both ends opposed in the Y direction, as position detecting electrodes (also referred to as bas bars) 25a and 25b of the upper panel 2, and as routing wires 25c and 25d routed from the electrodes 25a and 25b to the FPC connection section.

The flexible transparent resin film 21 includes a resin such as PET or PC.

The conductive paste to form the transparent conductive film 22, the electrodes 25a and 25b, and the routing wires 25c and 25d is similar to the description of the lower panel 1.

The FPC 3 serving as the connector includes terminals 32a, 32b, 32c, and 32d serving as a conductive pattern formed on one surface of an insulating resin film 31 including PET or the like, and the terminals 32a, 32b, 32c, and 32d are connected to the routing wires 15c, 15d, 25c, and 25d, respectively with a material such as a conductive bonding material.

The terminals 32a and 32c from the electrodes 15b and 25b are connected to a power supply Vcc through switches SW1 and SW2 (both not shown). The terminals 32b and 32d from the electrodes 15a and 25a are grounded through switches SW3 and SW4 (both not shown) and connected to terminals to detect X coordinate and Y coordinate in a detection circuit (not shown), respectively.

In addition, the upper panel 2 and the lower panel 1 are connected with one end of the FPC interposed therebetween in the above embodiment, but they may be connected by a through hole which is provided in the lower panel 1.

The transparent bonding layer 4 to bond the first member and the second member is composed as will be described below. That is, the transparent bonding layer 4 is an insulating member which includes many uniformly dispersed through holes 4a, has adhesiveness to bond the first member and the second member, and retains a gap between the transparent conductive films 12 and 22. Therefore, it is not necessary to provide dot spacers in the present invention. The transparent bonding layer 4 may be formed such that a coreless two-sided adhesive tape is punched out. A thickness of the transparent bonding layer 4 is set to 0.01 to 2 mm, for example.

Since the first member and the second member are bonded with the transparent bonding layer 4 having many through holes 4a, air gaps only exist in the through holes 4a between the upper and lower transparent conductive films 12 and 22. Therefore, light reflection generated at a boundary with an air layer is low, so that visibility is improved in the display section of the image display device.

Each through hole 4a preferably has a diameter larger than that of the pressure sensitive ink member 5 by 0.05 to 2 mm. When the diameter is larger by 0.01 mm or more, the transparent bonding layer 4 and the pressure sensitive ink member 5 do not overlap with each other even when a position shifts in bonding the transparent bonding layer 4. In addition, when the diameter is not to be larger by more than 2 mm, the transparent conductive films 12 and 22 are surely prevented from being connected without the pressure sensitive ink member 5, and the through hole 4a is unnoticeable.

The pressure sensitive ink member 5 to detect the pressed position and the strength of the pressed force is composed as will be described below. That is, the pressure sensitive ink member 5 is arranged in each of the through holes 4a of the transparent bonding layer 4, and its electric characteristics is changed by the applied pressed force. A composition of the pressure sensitive ink member 5 includes a material whose electric characteristics such as an electric resistance value are changed based on an external force. The composition may be a quantum tunneling composite material which is available as a product name “QTC” from Peratech Limited in England. The pressure sensitive ink member 5 is formed by a printing method such as screen printing, off-set printing, gravure printing, or flexographic printing.

It is preferable that the pressure sensitive ink member 5 is a dot having a diameter of 0.01 mm to 1 mm, and the through hole and the pressure sensitive ink member in the through hole are arranged at a pitch of 0.1 mm to 10 mm. When the pitch is less than 0.1 mm, it is difficult to recognize an image on the screen positioned on a rear surface. In addition, when the pitch is more than 10 mm, detection precision is lowered.

The pressure sensitive ink member 5 may be formed on at least one surface of opposed surfaces of the first member and the second member, but more preferably, the pressure sensitive ink member 5 is formed on a side of the lower panel 1 serving as the first member as formed in this embodiment. Because, the upper panel 2 is flexible and then, likely to be subjected to stress.

In addition, it is more preferable that the pressure sensitive ink member 5 is in contact with both opposed surfaces of the first member and the second member. Because, a small inputted load can be detected. When the air layer is left in each of the through holes 4a of the transparent bonding layer 4 between the first member and the second member, a distance of the air layers is up to 0.5 mm from the above reason.

When a position of a point P on the upper panel 2 is pressed, the transparent resin film 21 is bent, and the external force is applied to the pressure sensitive ink member 5 sandwiched between the transparent conductive films 12 and 22 in the vicinity of the point P. When the pressure sensitive ink member 5 receives the external force, its resistance value is changed and the upper and lower transparent conductive films 12 and 22 are electrically connected through the pressure sensitive ink member 5. At this time, similar to the conventional technique, when the switches SW1 and SW3 are turned on and the switches SW2 and SW4 are turned off, the power supply voltage Vcc and the ground voltage are applied between the electrodes 15a and 15b, so that a partial voltage of the power supply voltage Vcc can be obtained from the electrode 25a, based on a position x of the point P in the X direction. This is outputted to the detection circuit (not shown) as an X coordinate detection signal. Similarly, when the switches SW2 and SW4 are turned on and the switches SW1 and SW3 are turned off, the power supply voltage Vcc and the ground voltage are applied between the electrodes 25a and 25b, so that a partial voltage of the power supply voltage Vcc can be obtained from the electrode 15b, based on a position y of the point P in the Y direction. This is outputted to the detection circuit (not shown) as a Y coordinate detection signal. In addition, an input is to be determined when the resistance value of the pressure sensitive ink member 5 exceeds a certain threshold value. Otherwise, a problem of an error input such as a wandering hand or erroneous touch is generated.

Thus, after the pressed position (X, Y coordinates) has been detected, the switches SW2 and SW2 are turned on and the switches SW1 and SW4 are turned off, so that the power supply voltage Vcc and the ground voltage are applied between the electrodes 25a and 15b. When the position of the point P is pressed, as for the pressure sensitive ink member 5 interposed for electrical conduction between the upper and lower transparent conductive films 12 and 22 in the vicinity of the point P, the electric resistance value of the lower pressure sensitive ink member 5 decreases as the applied external force increases. Thus, as the pressed force to a touch input surface of the touch panel increases, a current flow increases between the upper and lower transparent conductive films 12 and 22. When the current change is converted to a voltage value and the voltage value is detected, the external force applied to the pressure sensitive ink member 5 can be detected, so that the pressed force to the touch input surface of the touch panel can be detected.

Incidentally, the touch panel shown in this embodiment can preferably function as the touch input device of the display of the electronic device, especially the mobile electronic device such as the mobile phone or game machine, and FIG. 4 shows an example where the touch panel of the present invention is mounted in the mobile phone.

FIG. 4 is a perspective view of the mobile phone incorporating the touch panel according to the one embodiment of the present invention. FIGS. 5A and 5B are cross-sectional views taken along line A1-A1 in FIG. 4.

As shown in FIG. 4, the mobile phone 101 has a synthetic-resin-made casing 102 having a display window 102A in its front surface, an image display device 103 having a liquid crystal or organic EL display section 103A and incorporated in the casing 102, a touch panel 104 fit in the display window 102A, and a plurality of input keys 105 arranged on the front surface of the casing 102.

The display window 102A of the casing 102 is formed so as to be recessed, to allow the touch panel 104 to be fit in. An opening 102a is formed in a bottom surface of the display window 102A so that the display section 103A of the image display device 103 can be viewed. The touch panel 104 is arranged on a frame section 102b around the opening 102a to close the opening 102a (see FIGS. 5A and 5B). The touch panel 104 may be fixed by a two-sided tape 107.

In addition, a shape or size of the display window 102A is variously changed based on a shape or size of the touch panel 104. The recessed section of the display window 102A can be variously changed based on a thickness of the touch panel 104, for example. A shape or size of the opening 102a of the display window 102A can be variously changed based on a size or size of the display section 103A. Here, the display window 102A, the opening 102a, the display section 103A, and the touch panel 104 each have a rectangular shape, and the recessed section of the display window 102A is set so that the surface of the casing 102 and the surface of the touch panel 104 are provided at the same level.

According to the touch panel 104 in this embodiment, as described above, the decorative film 6 and the hard coat film 7 are sequentially bonded to the surface of the upper panel 2 opposite to the surface opposed to the lower panel 1 with the transparent bonding agent to compose the second member. Therefore, as shown in FIG. 4, there is a transparent window section 104A, and a frame-shaped decorative region 104B arranged around the transparent window section 104A. After the touch panel 104 has been arranged in the display window 102A of the casing 102 of the mobile phone, the display section 103A of the image display device 103 can be viewed from the transparent window section 104A.

The decorative film 6 shown in FIG. 2 is formed by applying ink into a frame shape on a peripheral surface of the transparent resin film similar to the upper panel 2. The decorative region 104B of the touch panel 104 serves as a decorative section 6a to which the ink has been applied, and a section (non-decorative section) 6b in which the decorative section 6a is not provided serves as the transparent window section 104A of the touch panel 104.

The ink of the decorative section 6a may be colored ink containing a resin such as a polyvinyl chloride series resin, polyamide series resin, polyester series resin, polyacryl series resin, polyurethane series resin, polyvinyl acetate series resin, polyester urethane series resin, cellulose ester series resin, or alkyd resin as a binder, and a pigment or dye having an appropriate color as a coloring agent. In addition, the decorative section 6a may be formed by printing method instead of application method. When the decorative section 6a is formed by printing, general printing such as off-set printing, gravure printing, or screen printing may be used.

In addition, the hard coat film 7 includes a polyethylene terephthalate (PET) resin or polyimide.

Furthermore, insulating PSAs 8, 9, and 10 including an acrylic resin, epoxy resin, phenol resin, or vinyl resin are used to bond the transparent plates 11, to bond the upper panel 2 and the decorative film 6, and to bond the decorative film 6 and the hard coat film 7, respectively.

In addition, the decorative film 6 is provided to form the configuration shown in FIGS. 5A and 5B in the above embodiment, but when the periphery of the touch panel is covered with a bezel, the decorative film 6 may not be provided.

### INDUSTRIAL APPLICABILITY

According to the present invention, since not only the pressed position (X, Y coordinates) of the screen, but also the Z direction (pressure) can be detected at the same time, the present invention can be usefully applied to an electronic device, especially a mobile electronic device such as a mobile phone or game machine.

### REFERENCE SIGNS LIST

1 lower panel
2 upper panel
3 FPC
4 transparent bonding layer (with holes)
4a through hole
5 pressure sensitive ink member
6 decorative film
6a decorative section
6b non-decorative section
7 hard coat film
8, 9, 10 PSA
11 transparent plate
12 transparent conductive film
15a, 15b position detecting electrode
15c, 15d routing wire
21 transparent resin film
22 transparent conductive film
25a, 25b position detecting electrode
25c, 25d routing wire
50 lower panel
51 glass plate
52 transparent conductive film
53a, 53b position detecting electrode
54 dot spacer
60 upper panel
61 transparent resin film
62 transparent conductive film
63a, 63b position detecting electrode
70 frame bonding layer
100 mobile phone
102 casing
102A display window
103 image display device
103A display section
104 touch panel
104A transparent window section
104B decorative region
105 input key
107 two-sided tape

1-5. (canceled)

6. A resistive film type touch panel with a pressing detection function serving as a resistive film type transparent touch panel provided by overlapping
a first member having a first transparent conductive film serving as a resistive film on an upper surface of a transparent plate, and a pair of first position detecting electrodes provided at both ends of the first transparent conductive film in a first direction, and
a second member having a second transparent conductive film serving as a resistive film on a lower surface of a flexible transparent film, and a pair of second position detecting electrodes provided at both ends of the second transparent conductive film in a second direction perpendicular to the first direction, in such a manner that the first and second transparent conductive films are opposed through a predetermined gap,
wherein a pressed point is detected based on a potential of the pair of the first and second position detecting electrodes,
the touch panel characterized in that the first member and the second member are bonded with a transparent bonding layer having many uniformly dispersed through holes between the first and second transparent conductive films, and
a conductive pressure sensitive ink member is arranged in each of the through holes, formed on at least one surface of opposed surfaces of the first member and the second member, and has electric characteristics to be changed by an applied pressed force.

7. The resistive film type touch panel with the pressing detection function, according to claim 6, wherein
the pressure sensitive ink member is a dot having a diameter of 0.01 mm to 1 mm, and the through hole and the pressure sensitive ink member in the through hole are arranged at a pitch of 0.1 mm to 10 mm.

8. The resistive film type touch panel with the pressing detection function, according to claim 6, wherein
the pressure sensitive ink member is arranged on the first member.

9. The resistive film type touch panel with the pressing detection function, according to claim 7, wherein
the pressure sensitive ink member is arranged on the first member.

10. The resistive film type touch panel with the pressing detection function, according to claim 6, wherein
the pressure sensitive ink member is in contact with both surfaces opposed to the first member and the second member.

11. The resistive film type touch panel with the pressing detection function, according to claim 7, wherein
the pressure sensitive ink member is in contact with both surfaces opposed to the first member and the second member.

12. The resistive film type touch panel with the pressing detection function, according to claim 8, wherein
the pressure sensitive ink member is in contact with both surfaces opposed to the first member and the second member.

13. The resistive film type touch panel with the pressing detection function, according to claim 6, wherein
the through hole is formed to have a diameter larger than that of the pressure sensitive ink member by 0.05 to 2 mm.

14. The resistive film type touch panel with the pressing detection function, according to claim 7, wherein
the through hole is formed to have a diameter larger than that of the pressure sensitive ink member by 0.05 to 2 mm.

15. The resistive film type touch panel with the pressing detection function, according to claim 8, wherein
the through hole is formed to have a diameter larger than that of the pressure sensitive ink member by 0.05 to 2 mm.

16. The resistive film type touch panel with the pressing detection function, according to claim 9, wherein
the through hole is formed to have a diameter larger than that of the pressure sensitive ink member by 0.05 to 2 mm.
